(19) United States
(12) Patent Application Publication
(10) Pub. No.: US 2024/0095677 A1
(43) Pub. Date: Mar. 21, 2024

(54) METHOD AND SYSTEM FOR GUIDANCE OF ARTIFICIAL INTELLIGENCE AND HUMAN AGENT TEAMING

(71) Applicant: David Mroczka, Babylon, NY (US)

(72) Inventor: David Mroczka, Babylon, NY (US)

(21) Appl. No.: 18/229,832

(22) Filed: Aug. 3, 2023

Related U.S. Application Data
(63) Continuation of application No. 16/946,949, filed on Jul. 13, 2020, now abandoned.
(60) Provisional application No. 62/873,180, filed on Jul. 11, 2019.

(51) Int. Cl. G06Q 10/101; G06Q 10/0635; G06Q 10/0637; G06Q 30/0202

(52) U.S. Cl. CPC G06Q 10/101; G06Q 10/0635; G06Q 10/06375; G06Q 30/0202

(57) ABSTRACT

A method for generating an optimal set of parameters for a design project of a product, in which subject matter experts, working with an artificial intelligence module, select a number of fundamental measurement factors that are related to a group of fundamental prime measurements, all of which in the aggregate comprise a product profile matrix. The fundamental measurement factors are weighted and scored so that the resulting matrix reflects the various aspect of the proposed design. Through an iterative process, the fundamental measurement factors are modified until the product profile matrix provides a set of satisfactory scores that yields an acceptably low risk in proceeding with the selected design.

### TECHNICAL FIELD

This invention relates to the use of artificial intelligence in conjunction with human agents in order to develop sets of optimized parameters implemented in product development, design and manufacturing.

### BACKGROUND OF THE INVENTION

Many organizations, whether in the private or government sectors, are continuously seeking to develop new products (goods or services) and/or improve on existing products. In any product design or re-design, there are numerous parameters that need to be considered by the product designer, that may relate to the specifics of the product itself, the personnel utilized to design the product, the marketplace, financial considerations, and the like. Certain of these design parameters are unique to some products, while some may overlap with other products. In some cases, a set of design parameters may be more important than in other cases. Product designers may be able to utilize information from prior designs, while in some cases there are parameters that are new and evolving and thus cannot be repeated from prior designs.

Often, these design parameters are disorganized, and the design process occurs in essentially an ad hoc manner. This often leads to inefficiencies in the product, inconsistencies across products from the same entity, and other like problems.

For example, the government may be seeking to advance the state of the art of products that it uses. As related to defense department activities, this may apply to any aspect of its organization from weapons systems and soldier equipment to medical products and information systems. In order to develop the most effective procurement actions, the government must select the best products for renewal or replacement. It must clearly state to its industrial supply base what it wants to accomplish, and it must determine the path that best benefits the military while effectively managing its budgets.

The government must interrogate proposals to determine which supplier presents the best value and lowest acceptable risk for the desired product. As such, it is essential to utilize the same criteria for selection as was used to develop the procurement product requirements.

The government also needs to track progress after award of contracts. Risks should be known and not discovered after the fact. Risks should continuously be reduced, and product developments should be progressing towards higher technology readiness levels while meeting the original stakeholder requirements.

### SUMMARY OF THE INVENTION

One of the primary goals of the system is to enable users to remove risks and inconsistencies in product development cycles (i.e. barriers and vulnerabilities) via inputs provided by subject matter experts and a set of scoring methodologies that implement a set of defined fundamental prime measurements. In essence, by defining and scoring these fundamental prime measurements (as will be further explained herein), there will be no risks to the product development cycle that exist outside of the three power sets of fundamental prime measurements (defined as the product fundamental prime measurement power set, the stakeholder fundamental prime measurement power set, and the market fundamental prime measurement power set.). Note that when used herein, a product includes goods and/or services, and a stakeholder may be any individual or organization.

By way of the system of present invention, different subject matter experts from various fields are able to universally access the system, via a user interface platform, with a common approach for providing scoring (weighting and ratings) to the various fundamental prime measurements as defined by the system. These weighted and scored fundamental prime measurements are then used to provide a more robust, efficient, consistent, cost-effective product design than what was otherwise available in the prior art. Artificial intelligence may also be used by the subject matter experts to make recommendations for the selection of subject matter experts to achieve the best team expertise, development and diversity, provide solution recommendations, as well as recommendations to minimize risk for a given project.

Thus, as further described herein, the present invention is a method for generating an optimal set of parameters for a design project of a product. A team of subject matter experts is selected, each of the subject matter experts having expertise in at least one aspect of the design of the product. A product profile matrix is generated, wherein the product profile matrix is a power set of a plurality of fundamental prime measurements. Each of the fundamental prime measurements is itself a power set of a plurality of lower order fundamental measurement factors associated with an aspect of the product. To accomplish this, each of the subject matter experts (optionally with the assistance of artificial intelligence) performs the steps of (i) selecting, from a project database, a plurality of fundamental measurement factors, (ii) assigning a weight of importance to each of the plurality of fundamental measurement factors, (iii) assigning an evidence score to each of the plurality of fundamental measurement factors, (iv) generating a total point score as a function of the weight and evidence score for each of the fundamental measurement factors, (v) generating a strategic score for the associated fundamental prime measurement by averaging the total point scores for the fundamental measurement factors that comprise the fundamental prime measurement, (vi) generating a set of composite scores for the power set of fundamental prime measurements as a function of the strategic scores, and (vii) assigning a risk factor to each of the composite scores. If a risk factor falls below a predetermined level, then steps (ii)-(vii) are repeated throughout the product development process until the risk factor no longer falls below the predetermined level.

In one embodiment, the fundamental prime measurements include product appeal, product value, and product reliability (forming a product fundamental prime measurement power set, stakeholder personnel, stakeholder process, and stakeholder finances (forming a stakeholder fundamental prime measurement power set), and market size, market demand, and market delivery (forming a market fundamental prime measurement power set). As utilized herein, a power set of a set S is the set of all of S's subsets, and it includes any and all possible constituents, as shown in FIG. 4. See also https://www.ics.uci.edu/˜alspaugh/cls/shr/powerset.html.

Optionally, the total point scores in a database for reuse is a subsequent design project. Further optionally, at least one of the fundamental measurement factors selected form the project database may have an associated previous total point score.

In some instances, artificial intelligence may be used to assist the subject matter experts in selecting the fundamental measurement factors. Or, in the alternative, artificial intelligence may be used to replace the subject matter experts in selecting the fundamental measurement factors. Notably, artificial intelligence may be used for recommendations for subject matter expert selection, recommendations for technology proliferation to new applications, recommendations of subject matter experts and technologies that can be integrated, recommendations of previously successful prime measurement factors from similar technologies, recommendations for evidence scoring (explained below), and a repository of all data for future use.

### BRIEF DESCRIPTION OF THE DRAWING

FIG. 1 is a block diagram of the overall system and user interactions of the preferred embodiment of the present invention.

FIGS. 2A, 2B and 2C illustrate generation of the nine fundamental prime measurements from groupings of fundamental measurement factors to form the product profile matrix used by the preferred embodiment of FIG. 1.

FIG. 3 is a flowchart of the overall methodology implemented by the preferred embodiment of FIG. 1.

FIG. 4 is a graphical representation of the power set defined by the product profile matrix in the preferred embodiment of FIG. 1.

FIG. 5 is a three-stage growth matrix showing iterative revisions made to the nine fundamental prime measurements of the product profile matrix of the preferred embodiment of FIG. 1.

FIG. 6 is a screen shot of a web page interface implemented by the preferred embodiment of FIG. 1.

### DETAILED DESCRIPTION OF THE INVENTION

The preferred embodiment of the present invention herein implements a system that is referred to as a Product Innovation Platform (PIP). Companies in various industries are able to bid on solicitations generated by the Product Innovation Platform. In the preferred embodiment, an innovation expert network (IEN) is comprised of multiple subject matter experts (SMEs) that operate in conjunction with the Product Innovation Platform as further described herein.

Subject matter experts assist the customer of the Product Innovation Platform (e.g. the government or a private entity) in determining a set of fundamental measurement factors (FMFs) that are geared towards specific products of interest. This is done manually by the SMEs as well as by using artificial intelligence. Eventually, the fundamental measurement factors are applied to a set of nine fundamental prime measurements (FPMs) that together comprise a product profile matrix (PPM). The SMEs assist along with AI in determining measurements, conducting analysis, providing specific knowledge related to products and technologies using these FMFs to generate the product profile matrix. The product profile matrix is a three by three matrix comprised of the nine top level most essential aspects of developing a technology/product by a company and delivering it to the market. The matrix does not change from project to project.

Companies can remove/reduce risks, accelerate development activities, and create value by targeting the most critical development activities. They can do so via continual improvement of the Product Profile Matrix scores. The company can also communicate internally, to team members, and to the government by communicating their scores and related development activities.

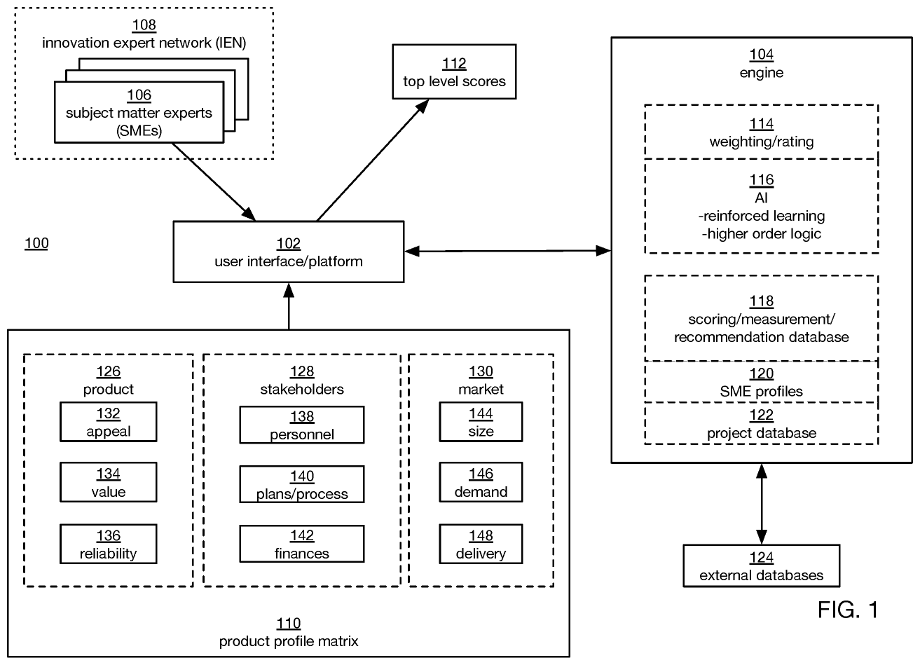

This patent application is based on the co-pending U.S. provisional application Ser. No. 62/873,180 of the inventor, entitled NOVEL SYSTEM FOR GUIDANCE OF ARTIFICIAL INTELLIGENCE AND HUMAN AGENT TEAMING, the specification of which is incorporated by reference herein. The preferred embodiment of the present invention will now be described with reference to the various Figures. FIG. 1 is a block diagram of the overall system and user interactions of the preferred embodiment of the present invention. The preferred embodiment system 100 (the Product Innovation Platform) has as its main components a user interface/platform 102 and a computing engine 104. A group of subject matter experts (SMEs) 106 form an innovation expert network 108 and interoperate with the engine 104 of the system 100 via the platform 102. The primary results of the work performed by the SMEs 106 with the engine 104 are a set of top level scores 112, which will be explained in further detail below.

The engine 104 may be a single computer or system of computers, accessible over a wide area network such as but not limited to the interne, that performs all of the data storage, processing, calculations, analysis, and artificial intelligence undertaken by the system 100 of the preferred embodiment of the present invention. The engine 104 will interface with the user interface/platform 102 that serves as the user interface, such as a web server, that allows interaction with the engine 104 by the various participants in the system such as end users, subject matter experts 106, and the like. The engine 104 includes a weighting/ranking module 114 that facilitates implementation of the fundamental prime measurements by the subject matter experts, and an artificial intelligence (AI) module 116 that uses higher order logic and reinforced learning in conjunction with the manual interactions of the subject matter experts 106. These modules are software modules programmed to perform the functions that are described in detail further herein.

The engine 104 also includes several databases such as an SME profile database 120 that implements a scoring system relevant to the qualifications of the network 108 of SMEs suitable for selection and engagement of appropriate SMEs 106 on a given project; as well as a scoring/measurement/recommendation database 118 that captures intelligence and stores historical data regarding scoring, fundamental prime measurements, and recommendations of the SMEs on past projects that may be accessed by the system (AI or manually) for implementation in subsequent projects, and a project database 122. These databases may be implemented in any available database software such as SQL or the like, as well known in the art. The databases 118, 120 and 122 may be stored on the same machine as the software comprising the engine 104, or they may be stored on a separate computer as may be desired. External databases 124 are also shown, which may be accessible via the internet to obtain information as will be further described herein.

The SME profiles database 120 tracks various data points for each SME 106 registered in the system. For example, in addition to the SME's name, title and contact information, the SME database 120 also tracks the compensation rate(s) for the SMEs, as well as a ranking score that reflects the desirability of the SME for subsequent work. This may be obtained through post-project evaluations from project administrators, other SMEs, etc. The SME database 120 may also indicate the current availability of an SME to work on a project, his education, experience and training levels, and a biographical statement that may be useful for future project selections.

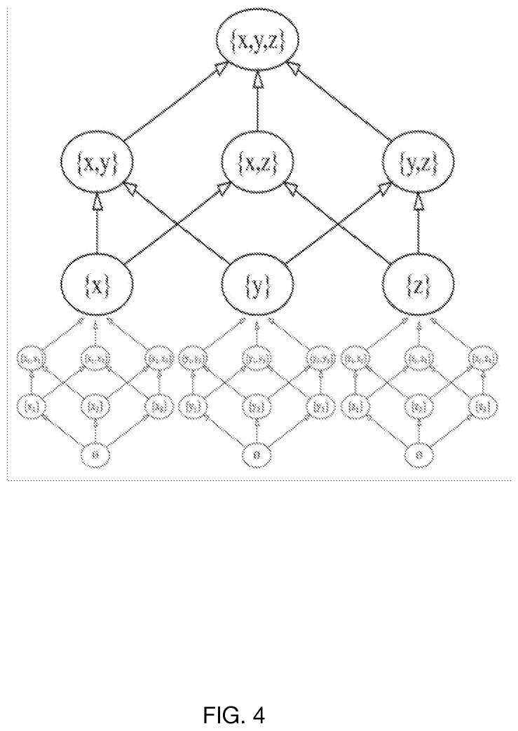

The artificial intelligence (AI) methodology employed by the AI module 116 implements reinforced learning and higher order logic (HOL) along with mathematical power sets, which are illustrated graphically in FIG. 4.

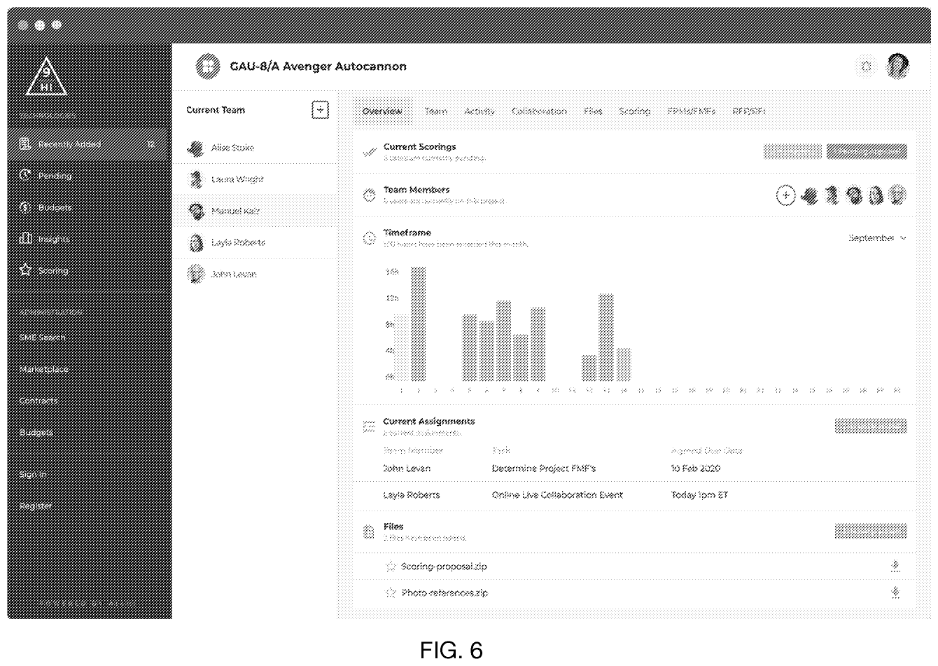

The user interface/platform 102 functions as the front end to the various users such as the SMEs 106, and as such may typically be a web server that interoperates over the internet or other wide area network (not shown for clarity), to provide for example a web page as shown in FIG. 6. Computer and network interoperations are well known in the art and need not be described in further detail herein.

Also shown graphically in FIG. 1 is a product profile matrix 110. The product profile matrix 110 is a construct of the system 100 that enables the SMEs 106 to generate accurate, timely, and robust data sets in order to map out various aspects of a product under development. The product profile matrix represents various power sets of data implemented by the system 100 and as such will be stored in and manipulated within the engine 104.

The product profile matrix 110 is a matrix of data that includes a top level set of three power sets; the product fundamental prime measurement power set 126, the stakeholders fundamental prime measurement power set 128, and the market fundamental prime measurement power set 130. These power sets include all data needed by the system in order to make product design and maintenance recommendations as determined in conjunction with the SMEs. Each power set is comprised of three fundamental prime measurements (FPMs) for a total of nine FPMs in the matrix. The product fundamental prime measurement power set 126 includes the appeal FPM power set 132, the value FPM power set 134, and the reliability FPM power set 136. Similarly, the stakeholders power set 128 includes the personnel FPM power set 138, the plans/process FPM power set 140, and the finances FPM power set 142. Finally, the market FPM power set 130 includes the size FPM power set 144, the demand FPM power set 146, and the delivery FPM power set 148.

SMEs and/or AI make recommendations based on scoring of the underlying fundamental measurement factors. In one embodiment, the final scores that are highest will automatically dictate which methodologies are implemented (e.g. the methodology with the highest score will be automatically implemented). In another embodiment, final scores are considered by a human decision maker but may not be the only factor considered in determining which methodology may be implemented in the product.

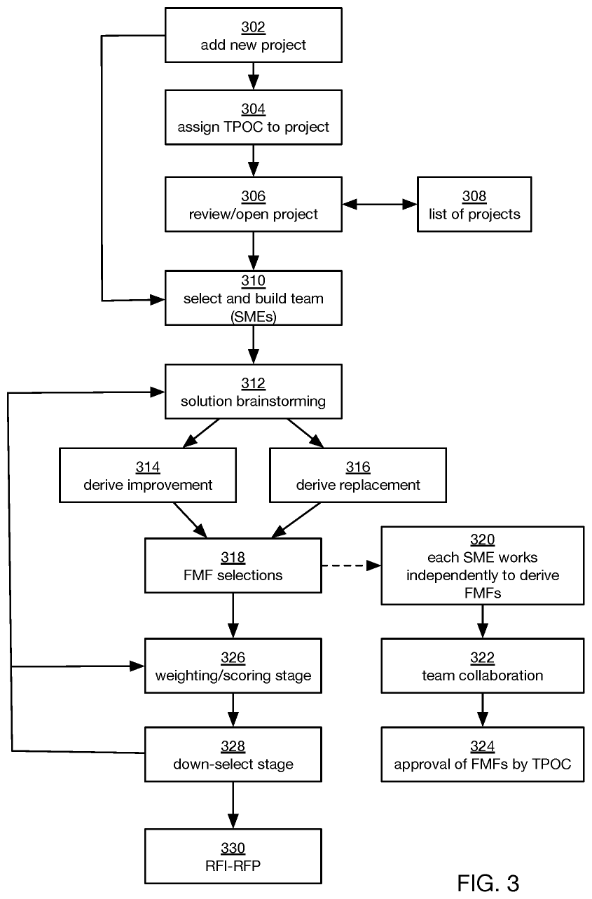

Referring to FIG. 3, the overall methodology implemented by the preferred embodiment is now described. At step 302, a new product development/design/redesign project is initiated, and at step 304, a technical point of contact (TPOC) is assigned to oversee development of the project. Technical points of contacts are generally those users of the system 100 who are responsible for the detailed determination and specification of technical requirements for products to be procured. The technical point of contact will, at step 306, review a list of existing projects 308 from the project database 122 to ascertain if a similar project has already been processed by the system, and if so, how much of the information stored in the database(s) may be reused for this project. Assuming that the new project has no historical precedent in the system, the technical point of contact will open a new project for processing.

At step 310, the technical point of contact will use the platform 102 to select and build a team of subject matter experts. Subject matter experts are individuals who provide a profile of skills so that they can be selected for a given project. SMEs provide their desired compensation rate and rely on feedback ratings and contributions of knowledge to raise their score against their peers.

In one embodiment in which the project is being implemented for or with a governmental agency (e.g. the Department of Defense, or DOD), an SME may be either a Government SME (G-SME) or an Industry SME (I-SME). A G-SME is generally a specialist in the government operations for which new products are being procured. They often are actual members of the user community—such as warfighters for defense applications—who bring a front-line understanding of user needs to the process. On the other hand, an I-SME is generally a specialist from industry, in defense markets and technology markets, with knowledge of technologies, products, and development techniques for products sought by the government. They can be engaged either early in the project as early measurements and scope are being derived, or after a development contract has been won by a contractor.

Subject matter experts form what is referred to as the Innovation Expert Network (IEN). This is a membership organization that allows access by the project leader to select a team of SMEs to execute various tasks of the project. The IEN is a social network of professionals who provide expertise and knowledge in various technical and product areas. It provides a means to upload personal capabilities and interests to create a personal/professional profile for each expert. Both government and industry personnel can access the IEN to identify SMEs needed for various product development efforts.

The subject matter experts may be reviewed by using a web site as shown in FIG. 6. The web page of FIG. 6, which in this example is show being used for a project entitled “GAU-8/A Avenger Autocannon,” provides the technical point of contact the ability to view data related to all of the available SME's in the system. By selecting the button labelled “SME Search”, the database of SME's becomes available for searching. In the example of FIG. 6, a set of five SMEs have already been chosen, as listed in the column labelled “Current Team.” BY selecting any of the subject matter experts on the current team, e.g. Laura Wright, their bio, availability, and other pertinent information is accessible.

The set of desired SMEs is chosen based upon criteria retrieved from the SME profiles database 120, including technical level of skill relevant to the current project, salary requirements, experience, and availability to work on the project. The technical point of contact will communicate with the selected SMEs to negotiate an agreement for them to work on the project. Eventually the final team of SMEs will be formed, and the project development project continues.

At step 312 of FIG. 3, an initial solution brainstorming process may be undertaken with the SMEs on the project, which may include any or all of the following: identify technology and select/assign the technology to standardized classification of family, phylum etc., create a taxonomy structure, establishment of a budget, and the like. Initial improvements may be derived (step 314), and/or replacements may be derived (step 316) at this stage.

The SMEs (operating optionally in conjunction with the artificial intelligence module) then execute an iterative process, the goal of which is to generate the product profile matrix 110 of FIG. 1. The product profile matrix 110 will be the framework by which the new product will be designed for maximum benefits such as cost, efficiency, reliability, etc. The product profile matrix 110 is a power set of three constituent power sets of fundamental prime measurements (FPMs), which are defined as the product fundamental prime measurement power set 126, the stakeholders fundamental prime measurement power set 128, and the market fundamental prime measurement power set 130. The product fundamental prime measurement power set 126 comprises the following three fundamental prime measurements: appeal 132, value 134, and reliability 136. The stakeholder fundamental prime measurement power set 128 comprises the following three fundamental prime measurements: personnel 138, plans/process 140, and finances 142. The market fundamental prime measurement power set 130 comprises the following three fundamental prime measurements: size 144, demand 146, and delivery 148. As such, all underlying parameters, factors and considerations that will be evaluated by the SMEs in generating the product profile matrix 110 can be grouped or categorized into one of these nine fundamental prime measurements. In particular, these underlying parameters, factors and considerations are referred to as fundamental measurement factors (FMFs).

In essence, these fundamental measurement factors are a subset of approximately 5-10 customized measurements that are used to calculate each of the nine fundamental prime measurements (FPMs) that together form the product profile matrix 110. Thes fundamental measurement factors are derived by the subject matter experts and are extracted from a library in the project database 122 and modified as necessary or derived at the onset of the project.

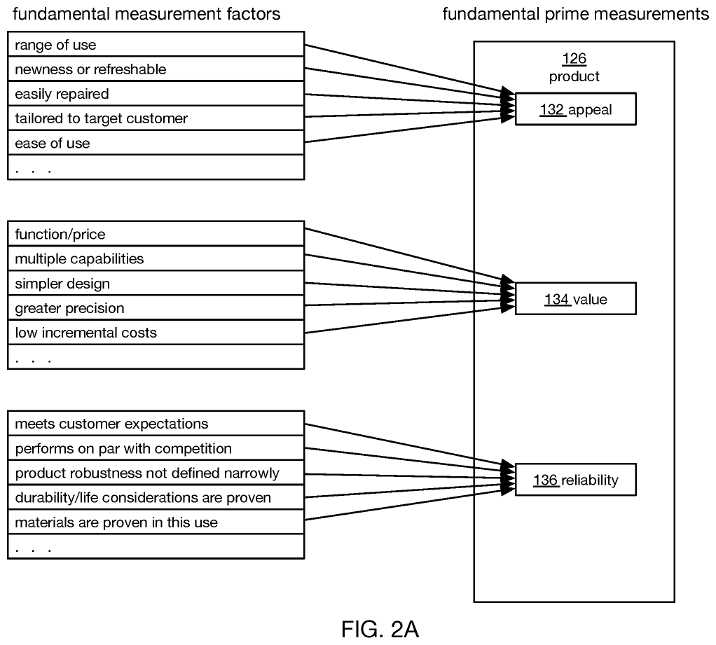

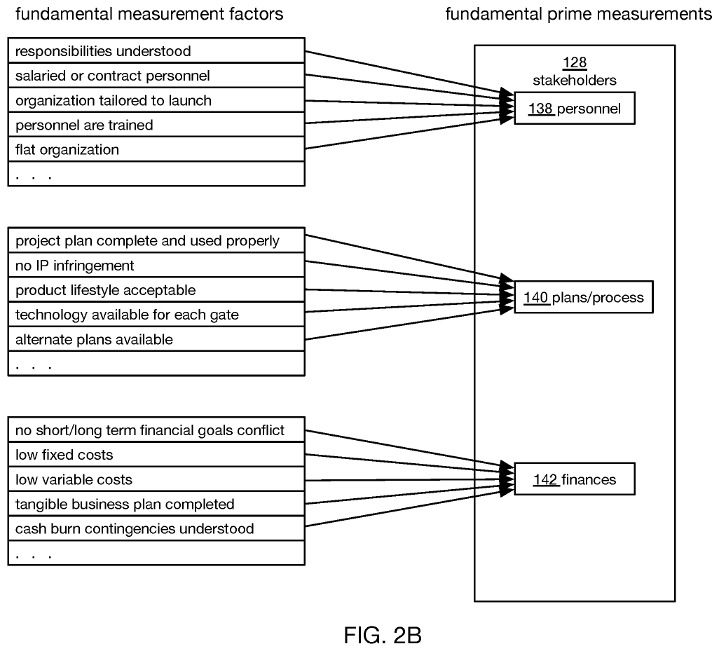

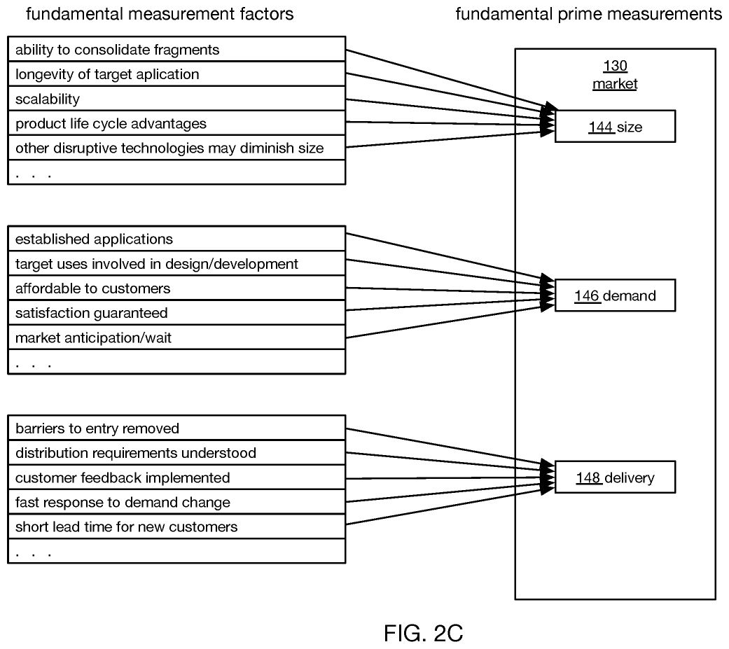

FIGS. 2A, 2B and 2C illustrate a typical set of fundamental measurement factors used to calculate the product 126, stakeholders 128, and market 130 fundamental prime measurement power sets in the product profile matrix, respectively. These fundamental measurement factors are selected (by the SMEs and or the AI module 116) and then grouped into the fundamental prime measurement power sets as follows:
Product fundamental prime measurement power set 126:
   1. Appeal fundamental prime measurement 132
      What is the range of use of the product?
      How do you characterize the newness and/or refreshability of the product?
      Is the product easily repaired, or must it be replaced often?
      How is the product tailored to the target customer?
      How easy or difficult is it to use the product?
   2. Value fundamental prime measurement 134
      How do the function and price interrelate to each other?
      Does the product have multiple capabilities or is it only good for one particular use?
      Can there be a simpler design of the product?
      Can the product be made with greater precision?
      Can the incremental cost of the product be made lower?
   3. Reliability fundamental prime measurement 136
      Does the product meet customer expectations?
      Does the product perform on par with the competition?
      Is the robustness of the product well defined?
      Does the product have proven durability/life considerations?
      Are the materials proven for his use case?
Stakeholder fundamental prime measurement power set 128:
   4. Personnel fundamental prime measurement 138
      Are the responsibilities of each stakeholder understood?
      Will the project use salaried or contract personnel?
      Is each organization tailored to launch?
      Are the relevant personnel trained?
      Is the relevant organization flat?
   5. Plans/process fundamental prime measurement 140
      Is the project plan complete and is it used properly?
      Is there any existing infringement of others' intellectual property?
      Is the product lifestyle acceptable?
      Are there alternate plans available?
   6. Finances fundamental prime measurement 142
      Do the short and long term financial goals conflict with each other?
      Are the fixed costs low?
      Are the variable costs low?
      Has a tangible business plan been completed?
      Are cash requirements understood?
Market fundamental prime measurement power set 130:
   7. Size fundamental prime measurement 144
      Can market fragments be consolidated?
      What is the longevity of the target application?
      What is the scalability of the project?
      Are there product life cycle advantages?
      Could other disruptive technologies diminish market size?
   8. Demand fundamental prime measurement 146
      Are there established applications for the product?
      Are users targeted in design/development?
      Is the product affordable to customers?
      Will satisfaction of the customer be guaranteed?
      What is the level of market anticipation?
   9. Delivery fundamental prime measurement 148
      Are there barriers to entry?
      Are the distribution requirements understood?
      Has customer feedback been implemented?
      Is there a fast enough response to change demand?
      Is there a short lead time for new customers?

In essence, the fundamental prime measurements are an organized superset of the individual fundamental measurement factors as set forth above and are implemented in order to identify opportunities and risks associated with a given project. For any given product development cycle, there is no risk or opportunity that exists outside of the nine FPMs as defined above. That is, any fundamental measurement factor that is or should be considered will be mapped to one of the FPMs, grouped as above. Although the specific individual fundamental measurement factors may vary from project to project, the nine fundamental prime measurements will always be present. For example, the appeal 132 of a product 126 will always be a factor in the product profile matrix, even though the constituent fundamental measurement factors that determine the product's appeal may vary from project to project, based on the specific requirements of the project.

Thus, at step 318, the fundamental measurement factors are selected by the team of SMEs. The SMEs recommend the appropriate measurement fundamental measurement factors for each of the nine fundamental prime measurement power sets. As shown by step 320, each subject matter expert will work independently to derive the appropriate fundamental measurement factors, at which point a team collaborative process occurs amongst the SMEs at step 322 to review and revise the FMFs, which are eventually approved by the technical point of contact at step 324.

Once the fundamental measurement factors have been decided on for the project, a weighting and scoring process for those FMFs is undertaken at step 326. For each of the fundamental measurement factors, the SME will assign a relative weight that reflects the importance of that particular fundamental measurement factor to the current project being analyzed. Since the weight of any given fundamental measurement factor will vary across various projects, its relative contribution to that project varies accordingly. For example, the following weighting (or importance rating) scale is implemented in the preferred embodiment of this invention:

TABLE 1
Importance Ratings

| Weight | Meaning |
|---|---|
| 5 | Absolutely necessary |
| 4 | Important |
| 3 | Good to have |
| 2 | Minor contribution |
| 1 | Never needed |

For example, a product having a primary use case in a remote wilderness area would have a repairability factor with a higher weight (e.g. 5) than would a product whose primary use case is in an area where product replacement is relatively easy (e.g. 2). That is, something that cannot be easily replaced (since its use is remote) must be easily repaired to be viable. In another example, a product that is expected to be produced in very small quantities would have a scalability factor that is weighted relatively lower (e.g. 1) than that of a product that is expected to be produced in higher quantities (e.g. 4). Each of the fundamental measurement factors is thus weighted by the SMEs in accordance with the specifics of that project.

In addition, an evidence score is assigned to each fundamental measurement factor by the responsible SME. The evidence score will reflect how well the proposed product meets that factor based on available evidence. The following evidence scoring scale is implemented in the preferred embodiment of this invention:

TABLE 2
Evidence Scoring Scale

| Score | Meaning |
|---|---|
| 9 | Confirmed evidence from multiple sources |
| | of superior performance (multiple time- |
| | based reports/analysis confirms trend or |
| | various sources give similar condition) |
| 8 | Confirmed evidence of success (may be |
| | apparent or require investigation or |
| | drill-down through a report, but must be |
| | based on facts, not opinions) |
| 7 | Limited success evidence (strong theory |
| | that is based on dated, parallel or |
| | distant comparison) |
| 6 | Convincing argument or subjective |
| | benefit evidence (theory or dated, |
| | parallel, or distant comparison) |
| 5 | Weak performance evidence (based on |
| | industry hearsay, rumor, guess or great |
| | assumption) |
| 4 | No argument and no evidence of success |
| | (baseless response) |

For example, a certain product may not be easily repairable, so the score for the repairability factor would be very low, for example a 5 (weak performance evidence). Evidence scores may be obtained through various methods, including prior performances that are stored in the scoring/measurement/recommendation database 118, external databases 124, personal knowledge of the SMEs, etc. For example, if an SME is able to confirm that a given factor has scored high based on prior history within the system, as well as reference to web-based sources (external databases), then he or she may assign a level 9 to that factor since there is confirmed evidence from more than one source (prior history and external web data) of superior performance. As such, the more a given factor is analyzed in the system over various projects, the more evidence may be obtainable on it, and the more likely that the confidence level will increase accordingly.

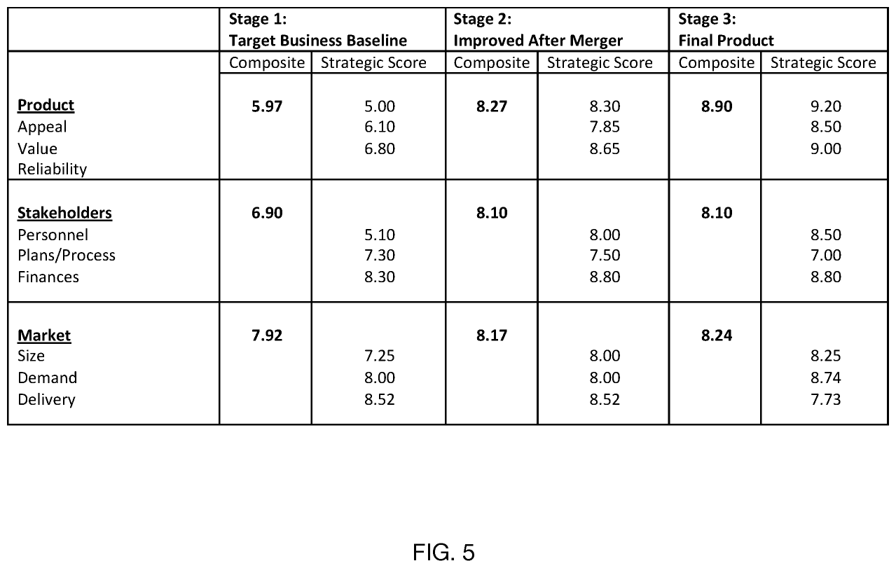

A total point score for each fundamental measurement factor is then derived by multiplying the weight of that fundamental measurement factor by the evidence score. In an alternative embodiment, an additional skewing factor may be used to further distinguish and separate differently weighted factors (e.g. a weighting of 5 may actually result in a multiplication factor of 20). In any event, all of the total points scores for the fundamental measurement factors under each fundamental prime measurement power set are summed, and then the average is calculated as the Strategic Score for that fundamental prime measurement. The result will be a set of nine Strategic Scores as shown in FIG. 5. There, the Strategic Scores are shown for the nine FPMs (appeal, value, reliability, personnel, plans/process, finances, size, demand, delivery). The Strategic Scores that are generated for the first iteration of the analysis are referred to as Stage 1 scores. Also shown in FIG. 5 is the composite score for each fundamental prime measurement power set (product fundamental prime measurement power set, stakeholder fundamental prime measurement power set, and market fundamental prime measurement power set), which is derived by averaging the Strategic Scores of the FPMs that comprise each fundamental prime measurement power set. Thus, the composite score for the product fundamental prime measurement power set (5.97) is the average of the Strategic Scores of its constituent FPMs of Appeal (5.00), Value (6.10), and Reliability (6.80).

Weighting factors and skewing factors may be adjusted as desired by the system designer in order to provide a meaningful range of scores that accurately reflect differences in the various factors and achieve a level of granularity and precision that is meaningful and robust. At step 328, the down-select stage is entered, where the composite scores are further analyzed to determine if they have met a certain level of acceptability. A break point range is defined against which the composite scores are compared to make this determination. In the preferred embodiment, the following break point range is utilized.

TABLE 3
Risk Analysis

| Range | Risk level |
|---|---|
| <7.00 | High risk |
| 7.00 < > 8.00 | Marginal |
| >8.00 | Low risk |

Thus, the composite score of 5.97 for the product fundamental prime measurement power set is a high risk, but the composite score of 7.92 for the market fundamental prime measurement power set is marginal. In fact, all three FPMs for the Product subset had Strategic Scores that were high risk (5.00 for Appeal, 6.10 for Value, and 6.80 for Reliability). All three of these FPMs will need to be improved upon in order to drive the Composite Score for the Product subset into an acceptable range. In the Market fundamental prime measurement power set, the Demand Strategic Score of 8.00 and 8.52 are low risk, but the marginal score for the Size FPM of 7.25 drove the Composite subset into the marginal range. Thus, only the Size FPM needs to be addressed in order to drive the Composite score for the Market fundamental prime measurement power set into the low risk range.

Since at least some of the FPMs require improved scores, the process loops back to step 312, where further solution brainstorming takes place or product development and testing may be required. The SMEs can analyze the FPMs that require improvement, and then implement revisions to the various processes at steps 314 and 316 that will cause the FPMs to increase, thus driving the scores in the desired direction. For example, at Stage 2, the scores have dramatically increased as can be seen in FIG. 5. The process in this example reiterates once more, resulting in the composite scores shown for Stage 3 (Final Product) in FIG. 5, all of which are in the low risk range. Optionally, the new iteration may re-enter the process flow at step 326 for the weighting and scoring stage.

Once acceptable composite scores are attained, the process proceeds to step 330, where RFIs (requests for information) and RFPs (requests for proposal) may be disseminated as well known in the industry. In one embodiment, scores generated by the system may be shared with proposed vendors, wherein those vendors are able to match the scores to their own stored capabilities to provide for a more seamless interaction.

In the preferred embodiment, a library of fundamental measurement factors is stored, for example in the project database shown in FIG. 1. Subject matter experts, acting individually and/or in concert with the artificial intelligence (AI) engine, will review the available fundamental measurement factors for a give type of project and develop a subset of those fundamental measurement factors that are deemed especially relevant to the current project. As shown in FIGS. 2A, 2B, and 2C, five of the most relevant fundamental measurement factors have been selected for his example for clarity of explanation; it is noted that dozens or even hundreds of such fundamental measurement factors may be utilized for a given project, as ascertained by the SMEs and/or AI engine. As the analysis of the available fundamental measurement factors, as well as their related scores sored from past projects, becomes more intricate, the system will rely more on the AI engine to cull out the most relevant FPMs for a given project.

When reviewing the library of fundamental measurement factors, the AI engine will determine which particular fundamental measurement factors were implemented on similar programs as the current one, and which of those helped to make that prior program successful. This automated process of culling out the most relevant fundamental measurement factors for a given program provides reliability and accuracy in the present invention since it saves critical amounts of time.

As scores are generated and evaluated for the various fundamental measurement factors, this data is stored in the scoring/measurement/recommendation database as shown in FIG. 1. The library of available data increase with each project so that subsequent projects can extract fundamental measurement factor scoring information for similar factors in order to streamline and make more efficient the product design process being undertaken. For example, a given project may be to upgrade the accuracy of a certain type of weapon; in this case the AI engine can review the fundamental measurement factors in which similar weapons have been designed with similar feature sets and in which the accuracy of such prior weapon designs has been considered to superior.

The scores that are used in this embodiment are relevant to specific design parameters such that changing the design parameters would change the score in accordance with the needs of the project. For example, use of a certain material (material A) for a given application may have an associated reliability score that is relatively high, but a value score that is low since its reliability makes it expensive. A second material (material B) may not be as reliable as material A, but it may cost less and thus have a higher value score. The subject matter expert and/or AI module can thereby choose either material depending on the relative importance of reliability vs. cost, analyze the effect on the product profile matrix, and adjust the material selection accordingly.

What is claimed is:

1. A method for generating an optimal set of parameters for a design project of a product comprising:
a) selecting a plurality of subject matter experts, each of said subject matter experts having expertise in at least one aspect of the design of the product;
b) generating a product profile matrix, wherein said product profile matrix is a power set of a plurality of fundamental prime measurements, wherein each of said fundamental prime measurements is a power set of a plurality of fundamental measurement factors associated with an aspect of the product, wherein said product profile matrix is generated by each of said subject matter experts performing the steps of:
i. selecting, from a project database, a plurality of fundamental measurement factors,
ii. assigning a weight of importance to each of the plurality of fundamental measurement factors,
iii. assigning an evidence score to each of the plurality of fundamental measurement factors,
iv. generating a total point score as a function of the weight and evidence score for each of the fundamental measurement factors,
v. generating a strategic score for the associated fundamental prime measurement by averaging the total point scores for the fundamental measurement factors that comprise the fundamental prime measurement;
vi. generating a set of composite scores for the power set of fundamental prime measurements as a function of the strategic scores;
vii. assigning a risk factor to each of the composite scores; and
viii. if a risk factor falls below a predetermined level, then repeating steps (ii)-(vii) with product development efforts until the risk factor does not fall below the predetermined level.

2. The method of claim 1 wherein the fundamental prime measurements comprise product appeal, product value, product reliability, stakeholder personnel, stakeholder process, stakeholder finances, market size, market demand, and market delivery.

3. The method of claim 1 comprising the further steps of storing the total point scores in a database for reuse is a subsequent design project.

4. The method of claim 1 wherein at least one of the fundamental measurement factors selected from the project database has an associated previous total point score.

5. The method of claim 1 further comprising the step of implementing artificial intelligence to assist the subject matter experts in selecting the fundamental measurement factors.

6. The method of claim 1 further comprising the step of implementing artificial intelligence to replace the subject matter experts in selecting the fundamental measurement factors.
